(19) United States
(12) Patent Application Publication
(10) Pub. No.: US 2011/0065080 A1
(43) Pub. Date: Mar. 17, 2011

(54) TV-BASED KARAOKE

(75) Inventor: Mahyar Nejat, La Jolla, CA (US)

(73) Assignees: SONY CORPORATION; SONY ELECTRONICS INC.

(21) Appl. No.: 12/561,519

(22) Filed: Sep. 17, 2009

(51) Int. Cl. G09B 5/00

(52) U.S. Cl. 434/307 A

(57) ABSTRACT

Combination of TV and karaoke machine allows for a new method of obtaining karaoke songs from the Internet, storing them locally at the TV, and subsequently playing audio of the song mixed with a singer's voice inputted through a USB microphone.

### I. FIELD OF THE INVENTION

The present application is directed generally to TV-based karaoke systems.

### II. BACKGROUND OF THE INVENTION

Karaoke is popular among amateur signers who sing lyrics, usually presented on a display screen, along with recorded music and/or video. A karaoke system has a mixing function for mixing and outputting a reproduced piece of music, that is, an accompaniment and a singer's voice input from a microphone. Typically a karaoke system incorporates a storage medium that stores accompaniment files in, e.g., musical instrument digital interface (MIDI) data format, and then mixes a singer's voice as received through a microphone with the MIDI data to output a song with the karaoke singer's voice in effect dubbing over the original lyrics. The display screen, e.g., a TV, commonly presents lyrics to the singer and can play the audio, perhaps in conjunction with a home stereo, premixed by the karaoke system.

As understood herein it would be advantageous to leverage TV capability to provide karaoke services. This is particularly true when a TV manufacturer also happens to own rights to songs that can be vended by means of the manufacturer's TVs, advantageously leveraging one business model using another commonly owned business model.

### SUMMARY OF THE INVENTION

A system includes a TV communicating with an Internet server storing karaoke songs the rights in which can be owned by a manufacturer of the TV or by a partner of the TV manufacturer. A processor receives at least one karaoke song owned by the manufacturer of the TV from the Internet server and a microphone is connected to the processor for providing to the processor voice data from a human karaoke user. The processor mixes the voice data with the karaoke song to output a mixture thereof. A speaker receives the mixture and audibly plays it.

If desired, the TV can further receive from the server video information keyed to the song. The TV includes a TV display and the TV processor causes the video information to be presented on the display synchronized with the playing of the mixture on the speaker.

If desired, the TV processor in response to input from a TV remote control may cause a user interface (UI) to be presented on the display, with the user interface listing plural inputs to the TV, one of the inputs being karaoke. If a user selects karaoke from the UI, the TV processor presents a second UI on the display listing at least two selectable karaoke functions, the two functions including “purchase karaoke song” and “select karaoke song”. In turn, if a user selects “purchase karaoke song” from the second UI the TV processor presents on the display a third UI including selections to enable a user to purchase a song in the server. On the other hand, if a user selects “select karaoke song” from the second UI the TV processor presents on the display a fourth UI including a list of purchased karaoke songs stored locally at the TV and available for play on the speaker.

In another aspect, a method includes providing karaoke songs on an Internet server, and presenting on a TV configured for communicating with the server a main user interface (UI). The main UI lists plural inputs to the TV, with one of the inputs being karaoke. In response to selection of karaoke as an input, UIs are selectively presenting on the TV in response to user inputs permitting purchasing and playing karaoke songs that are mixed with a user's voice received from a microphone communicating with the TV.

In another aspect, a system includes a TV communicating with an Internet server storing karaoke songs, a processor receiving at least one karaoke song from the Internet server, and a microphone connected to the processor for providing to the processor voice data from a human karaoke user. The processor mixes the voice data with the karaoke song to output a mixture thereof. A speaker receives the mixture and audibly plays it. The TV processor, in response to input from a TV remote control, causes a main user interface (UI) to be presented on the TV display. The main UI lists plural inputs to the TV. One of the inputs is karaoke.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a screen shot of an example user interface presented on the TV to enable selection of karaoke services;

FIG. 3 is a screen shot of an example user interface presented on the TV to enable selection of karaoke functions;

FIG. 4 is a screen shot of an example user interface presented on the TV to enable buying karaoke songs through the TV;

FIG. 5 is a screen shot of an example user interface presented on the TV to enable selecting karaoke songs to be played through the TV; and

FIG. 6 is a flow chart of example logic in accordance with present principles.

### DETAILED DESCRIPTION OF THE PREFERRED EMBODIMENT

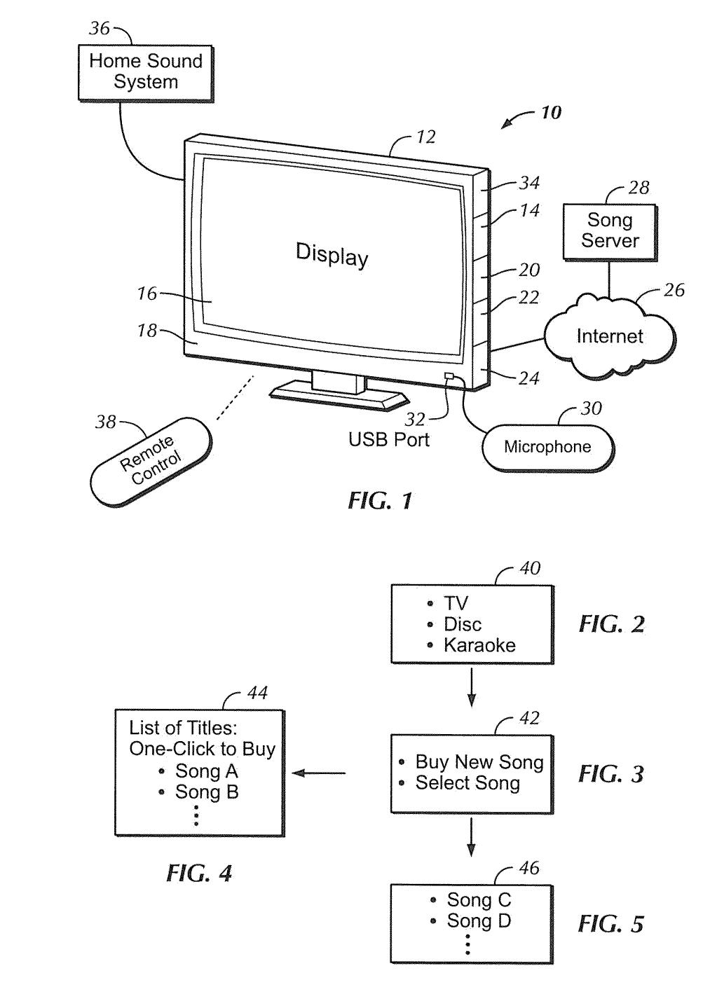

FIG. 1 presents a block diagram of an example karaoke system 10 that presents lyrics/video on a TV 12, commonly containing a TV tuner 14 and a display screen 16 implanted in or molded into a bezel casing 18. A storage medium 20, a microprocessor 22, and an Internet interface 24 are commonly integrated into a given TV 12 and have the capacity for storing media files, processing electrical signals, and connecting to and sharing information over the Internet 26 and its associated servers, e.g., a song server 28, respectively. The storage medium 20, which may be and electronic storage medium storing data in appropriate format that can be input and accepted by the TV processor, may store karaoke songs the rights of which are owned by a manufacturer of the TV 12 or by, e.g., a business partner of the manufacturer which can license songs and share revenue with the TV manufacturer. The Internet interface 24 in the TV 12 may equivalently be embodied in a set-top box or set-back box that is connected to the TV processor 22 but externally housed.

The karaoke system 10 thus operates by mixing the audio/video files by means of the processor 22 either preloaded on the storage medium 20 or downloaded from the Internet 26 with the singer's voice inputted through a microphone 30 linked via a USB port 32, and subsequently plays the mixed audio on either speakers 34 also housed in the bezel 18 of the TV 12 or a home sound system 36. To this end, the processor may implement a mixer in software or may access a separate chip-implemented mixer in the TV. User functions such as selecting a song that is to be displayed/played and downloading media files from the Internet 26 can be performed by means of a remote control 38. The TV 12 may additionally receive from the server 28 video information keyed to the song, the TV processor 22 causing the video information to be presented on the display 16 synchronized with the playing of the mixture on the speaker(s) 34.

Moving in reference to FIG. 2, a screen shot 40 displayed on a TV 12 acts as the user interface, granting the user the selection of inputs, or operation modes, e.g., karaoke through the use of the remote control 38. Once the karaoke mode is selected, the next screen shot 42, also FIG. 3, displays text or picture suggestion to either buy a new song or select a preloaded/downloaded song. Selection of the “buy new song” option directs the display of screen shot 44, also FIG. 4, accordingly introducing to the user a selection of song titles that can be purchased by clicking once or affirmatively commanding with the remote control 38.

Rather than buying a new song, perhaps the “select song” option presented on screen shot 42, also FIG. 3, was indeed selected, then screen shot 46, also FIG. 5, would be presented to the user and would allow the user to browse preloaded or purchased/downloaded song titles stored locally in the storage medium 20. In either case, video may be received from the server 28 or stored at the TV 12 locally and played in tandem with the mixed audio.

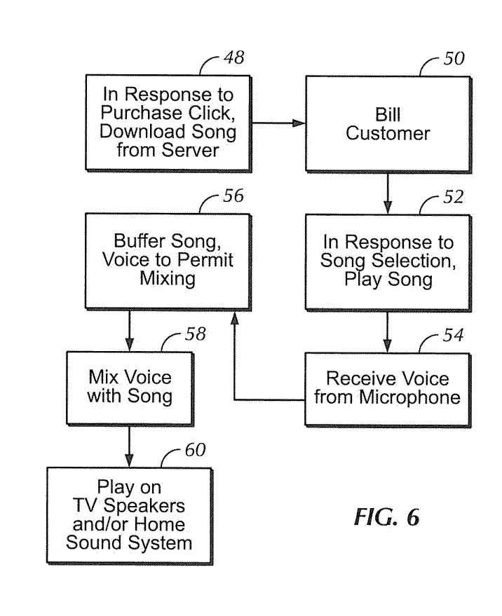

Now referring to FIG. 6, a flow chart of the example logic in accordance with presented principles, chronologically illustrated are the steps involved in an example non-limiting process of purchasing and obtaining karaoke songs. Once a song is selected for purchase, as in FIG. 4 screen shot 44, the song is downloaded from the song server at block 48. Due to the remote nature of the song purchase, the customer is automatically billed at block 50. Once downloaded, the purchased song may be selected as in FIG. 5 screen shot 46 and played, block 52. During the course of the song, the user inputs his/her voice, which is received from the microphone 30 at block 54 and buffered along with the song to permit mixing as in block 56. Once both audio inputs are buffered, they may be mixed at block 58 and audibly played through TV speakers 34 or home sound system 36 at block 60.

As recognized herein, the processor with mixer, however implemented, establishes a volume for the microphone (voice) input that matches the volume of the soundtrack with which the voice is mixed. Or, the soundtrack volume may be established to match that of the microphone (voice) input. Or, both volumes may be changed to some intermediate value, but in any case the decibel level of the microphone (voice) input is matched within a threshold range with the decibel level of the soundtrack with which the voice is mixed, so that neither audibly overwhelms the other when played on the speaker.

While the particular TV-BASED KARAOKE is herein shown and described in detail, it is to be understood that the subject matter which is encompassed by the present invention is limited only by the claims.

What is claimed is:

1. System comprising:
a TV communicating with an Internet server storing karaoke songs the rights in which are owned by a manufacturer of the TV;
a processor receiving at least one karaoke song owned by the manufacturer of the TV from the Internet server;
a microphone connected to the processor for providing to the processor voice data from a human karaoke user, the processor mixing the voice data with the karaoke song to output a mixture thereof; and
at least one speaker receiving the mixture and audibly playing it.

2. The system of claim 1, wherein the TV further receives from the server video information keyed to the song, the TV including a TV display, the TV processor causing the video information to be presented on the display synchronized with the playing of the mixture on the speaker.

3. The system of claim 1, the TV including a TV display, the TV processor in response to input from a TV remote control causing a user interface (UI) to be presented on the display, the user interface listing plural inputs to the TV, one of the inputs being karaoke.

4. The system of claim 3, wherein if a user selects karaoke from the UI, the TV processor presents a second UI on the display listing at least two selectable karaoke functions, the two functions including “purchase karaoke song” and “select karaoke song”.

5. The system of claim 4, wherein if a user selects “purchase karaoke song” from the second UI the TV processor presents on the display a third UI including selections to enable a user to purchase a song in the server.

6. The system of claim 4, wherein if a user selects “select karaoke song” from the second UI the TV processor presents on the display a fourth UI including a list of purchased karaoke songs stored locally at the TV and available for play on the speaker.

7. Method comprising:
providing karaoke songs on an Internet server;
presenting on a TV configured for communicating with the server a main user interface (UI), the main UI listing plural inputs to the TV, one of the inputs being karaoke; and
in response to selection of karaoke as an input, selectively presenting on the TV in response to user inputs UIs permitting purchasing and playing karaoke songs that are mixed with a user's voice received from a microphone communicating with the TV.

8. The method of claim 7, wherein the TV further receives from the server video information keyed to a karaoke song, the TV including a TV display, a TV processor in the TV causing the video information to be presented on the display synchronized with the playing of the karaoke song on the speaker.

9. The method of claim 7, wherein if a user selects karaoke from the main UI, the method includes presenting a second UI on the TV listing at least two selectable karaoke functions, the two functions including “purchase karaoke song” and “select karaoke song”.

10. The method of claim 9, wherein if a user selects “purchase karaoke song” from the second UI the method includes presenting on the TV a third UI including selections to enable a user to purchase a song in the server.

11. The method of claim 9, wherein if a user selects “select karaoke song” from the second UI the method includes presenting on the TV a fourth UI including a list of purchased karaoke songs stored locally at the TV and available for play on the speaker.

12. System comprising:
a TV communicating with an Internet server storing karaoke songs;
a processor receiving at least one karaoke song from the Internet server;
a microphone connected to the processor for providing to the processor voice data from a human karaoke user, the processor mixing the voice data with the karaoke song to output a mixture thereof;
at least one speaker receiving the mixture and audibly playing it;
a TV display, the TV processor in response to input from a TV remote control causing a main user interface (UI) to be presented on the display, the main UI listing plural inputs to the TV, one of the inputs being karaoke.

13. The system of claim 12, wherein the TV further receives from the server video information keyed to the song, the TV including a TV display, the TV processor causing the video information to be presented on the display synchronized with the playing of the mixture on the speaker.

14. The system of claim 12, wherein if a user selects karaoke from the main UI, the TV processor presents a second UI on the display listing at least two selectable karaoke functions, the two functions including “purchase karaoke song” and “select karaoke song”.

15. The system of claim 14, wherein if a user selects “purchase karaoke song” from the second UI the TV processor presents on the display a third UI including selections to enable a user to purchase a song in the server.

16. The system of claim 14, wherein if a user selects “select karaoke song” from the second UI the TV processor presents on the display a fourth UI including a list of purchased karaoke songs stored locally at the TV and available for play on the speaker.
